(19) United States
(12) Patent Application Publication
(10) Pub. No.: US 2010/0309671 A1
(43) Pub. Date: Dec. 9, 2010

(54) LED LAMP HEAT DISSIPATING MODULE

(76) Inventors: George Anthony Meyer, IV, San Jose, CA (US); Chien-Hung Sun, Zhongli City (TW); Chieh-Ping Chen, Zhongli City (TW)

Correspondence Address: HDLS Patent & Trademark Services, P.O. BOX 220746, CHANTILLY, VA, 20153-0746, US

(21) Appl. No.: 12/480,833

(22) Filed: Jun. 9, 2009

(51) Int. Cl. F21V 29/00

(52) U.S. Cl. 362/373

(57) ABSTRACT

A heat dissipating module embedded into an LED lamp house for dissipating heat of an LED light emitting element includes two flat heat pipes, a heat dissipating body and a conducting base. The heat dissipating body includes a cylindrical pillar, heat sinks radially formed around the cylindrical pillar, two longitudinal through grooves at the cylindrical pillar for passing a condensation section of the flat heat pipe. The conducting base includes corresponding first and second surfaces, and the first surface is attached to an evaporation section of the flat heat pipe, and the second surface is attached to the LED light emitting element. The conducting base perpendicular to an axis of the cylindrical pillar includes an embedding slot for embedding the heat dissipating module into an internal wall of the lamp house, such that the heat dissipating module can quickly dissipate the heat generated by the LED light emitting element.

### BACKGROUND OF THE INVENTION

1. Field of the Invention

The present invention relates to a heat dissipating apparatus, and more particularly to a heat dissipating module installed to a light emitting diode (LED) lamp.

2. Description of Prior Art

Since light emitting diode (LED) features a low power consumption, a long life expectancy, a small volume and a quick response, it gradually replaces traditional light bulbs and is used extensively in various different light emitting devices. To increase the illumination range and brightness of an LED, a plurality of LEDs are combined into an LED module. As the quantity of LEDs increases and the high power LED advances, the heat generated by the LED module gradually increases, and thus results in a shorter life expectancy of an LED lamp and higher maintenance and application cost, if the heat cannot be dissipated timely.

To dissipate the high heat generated by the LED lamp, most LED lamp sets install a heat dissipating apparatus for controlling the working temperature of the LED to maintain the normal operation of the LED lamp. The conventional LED lamp set is generally installed on a conducting base which is attached and coupled to the bottom side of a lamp house, and a plurality of parallelly and equidistantly arranged heat dissipating fins disposed at a surface of the lamp house, such that the conducting base can be used for conducting the heat generated by the LED lamp set to each heat dissipating fin.

In the aforementioned heat dissipating apparatus, the heat generated by the LED lamp set is conducted to the conducting base first, and then from the conducting base to the bottom of the lamp house, and finally from the bottom of the lamp house to each heat dissipating fin. Since the heat transmission is achieved by a contact conduction method, the conduction path is relatively long, the heat conduction is relatively non-uniform, and the heat dissipation speed is relatively slow. Obviously, the heat dissipating efficiency of this method is insufficient for the high power LED.

### SUMMARY OF THE INVENTION

It is a primary objective of the present invention to provide an LED lamp heat dissipating module for transmitting the heat generated by an LED to a heat dissipating body quickly, so that the LED lamp can continue its operation at an appropriate working temperature and achieve the effects of extending the life expectancy and improving the cost-effectiveness and practicality of the LED lamp heat dissipating module.

To achieve the foregoing objective, the present invention provides an LED lamp heat dissipating module embedded with a flange of an internal wall of a lamp house for dissipating the heat of an LED light emitting element. The heat dissipating module comprises at least two flat heat pipes, a heat dissipating body and a conducting base, and the flat heat pipe has a condensation section and an evaporation section, and the heat dissipating body includes a cylindrical pillar, a plurality of heat sinks radially formed at an external periphery of the cylindrical pillar, and the cylindrical pillar includes at least two through grooves for passing the condensation section, and the conducting base has corresponding first and second surfaces, wherein the first surface is attached to the evaporation section, and the second surface is attached to the LED light emitting element, and the conducting base has an embedding slot disposed at the periphery of the conducting base and embedded with a flange of an internal wall of a lamp house.

Compared with the prior art, the present invention conducts a large quantity of heat by a phase change of a working fluid in the two flat heat pipes, and the heat generated by the LED is transmitted to the conducting base quickly. Since the contact area of the flat heat pipes and the heat dissipating body is large, therefore the heat can be conducted to the heat dissipating body uniformly, and then a heat sink with a large heat dissipating area is used to dissipate the heat, such that the LED lamp set can continue its operation at an appropriate working temperature. In addition, the present invention further comprises an embedding slot disposed at the periphery of the conducting base for facilitating the embedment of the heat dissipating module to the internal wall of the lamp house to improve the convenience of the assembling process.

### BRIEF DESCRIPTION OF DRAWINGS

FIG. 1 is a perspective view of the present invention;

FIG. 2 is an exploded view of the present invention;

FIG. 3 is a cross-sectional view of the present invention;

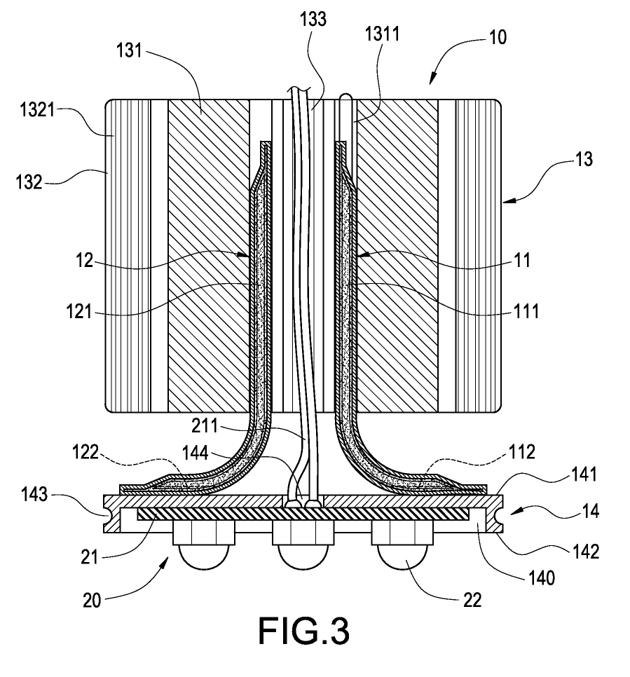

FIG. 4 is a schematic view of assembling an LED lamp heat dissipating module to a lamp house in accordance with the present invention; and

FIG. 5 is a schematic view of using the present invention.

### DETAILED DESCRIPTION OF THE INVENTION

The technical characteristics, features and advantages of the present invention will become apparent in the following detailed description of preferred embodiments with reference to the accompanying drawings, and the preferred embodiments are used for illustrating the present invention only, but not intended to limit the scope of the invention.

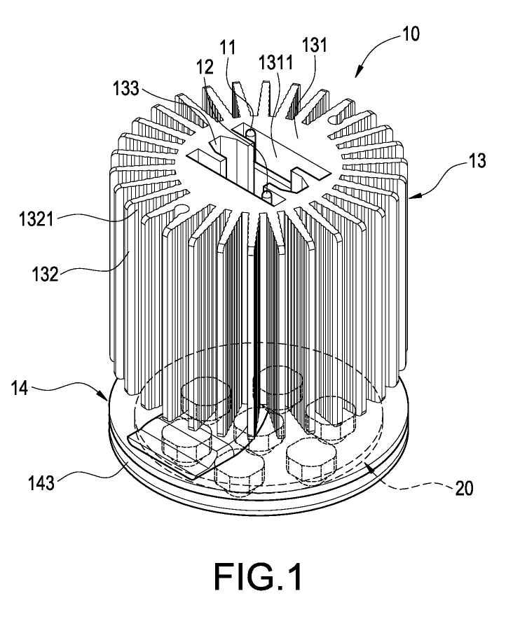

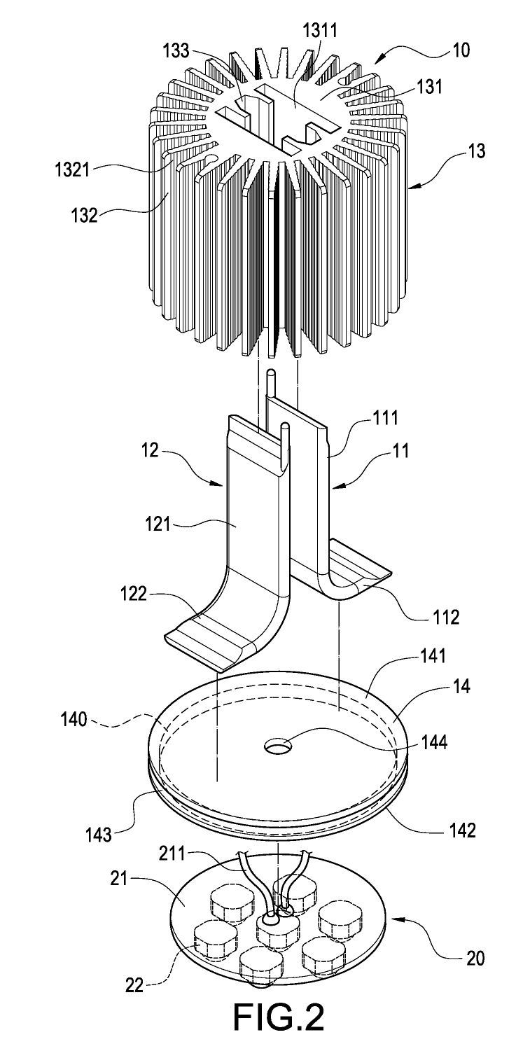

With reference to FIGS. 1 and 2 for a perspective view and an exploded view of the present invention respectively, the present invention provides an LED lamp heat dissipating module 10 for dissipating heat of an LED light emitting element 20, and the LED lamp heat dissipating module 10 comprises at least two flat heat pipes 11, 12, a heat dissipating body 13 and a conducting base 14.

The two flat heat pipes 11, 12 are substantially L-shaped, and each has a condensation section 111, 121 and an evaporation section 112,122, wherein each evaporation section 112, 122 is a bent section, and the two bent sections are disposed outwardly and attached to the conducting base 14.

The heat dissipating body 13 includes an aluminum extruded heat dissipating fin of a cylindrical pillar 131, a plurality of heat sinks 132 radially formed at an external periphery of the cylindrical pillar 131, a plurality of trenches 1321 formed on a surface of the heat sink 132 for increasing the heat dissipating area, at least two longitudinal through grooves 1311 disposed at the cylindrical pillar 131 for passing the condensation sections 111, 121, wherein the quantity of through grooves corresponds to the quantity of flat heat pipes, and a through hole 133 is disposed between the through grooves 1311.

The conducting base 14 with a good conductivity can be made of aluminum, copper or any equivalent metal, and the conducting base 14 is perpendicular to the axis of the cylindrical pillar 131 and has corresponding first surface 141 and second surface 142, wherein the first surface 141 is attached to the evaporation sections 112, 122, and the conducting base 14 has an embedding slot 143 disposed at the periphery of the conducting base 14, and a penetrating hole 144 at the center of the conducting base 14, and the second surface 142 is attached to the LED light emitting element 20, and the LED light emitting element 20 includes a circuit board 21 of a power supply line 211, and a plurality of light emitting diodes 22 installed on the circuit board 21 and electrically coupled with the circuit board 21. In addition, the conducting base 14 includes a containing space 140 for containing the LED light emitting element 20, wherein the top of the containing space 140 is the second surface 142, and the circuit board 21 is attached to the second surface 142, and the power supply line 211 of the LED light emitting element 20 is passed through the penetrating hole 144 and finally through the through hole 133 of the heat dissipating body 13 to the outside.

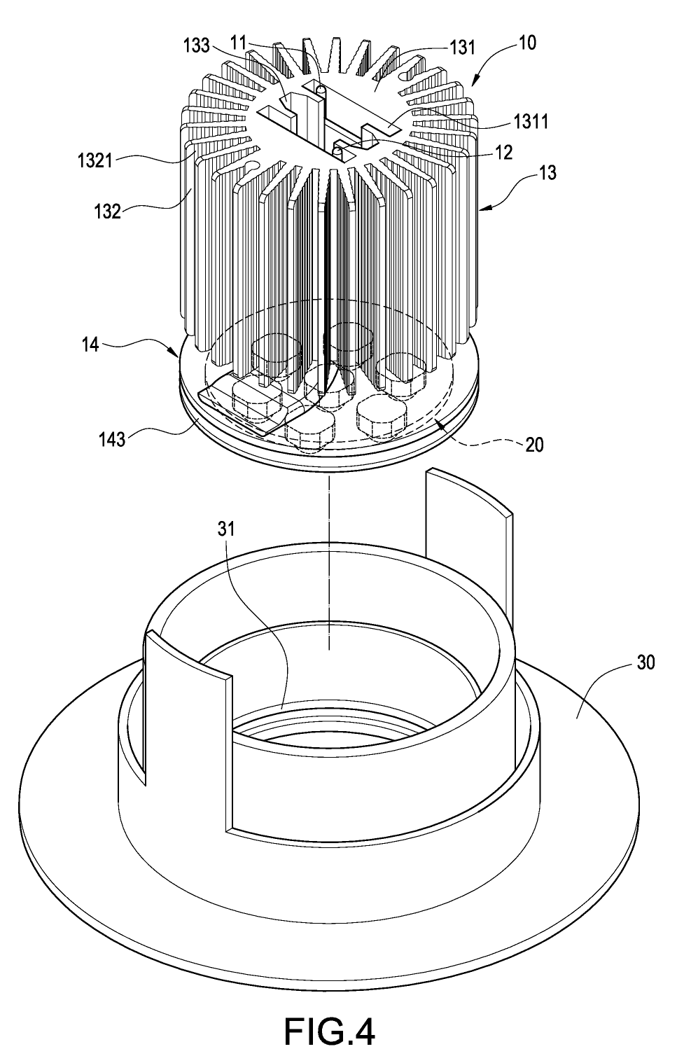

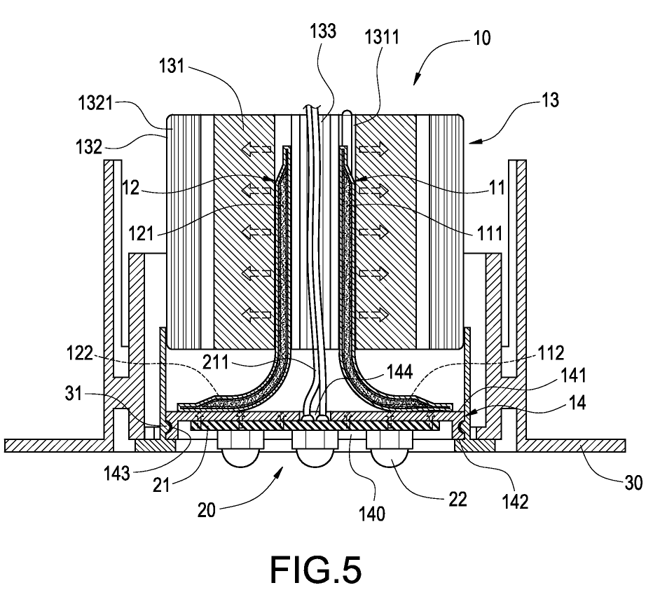

With reference to FIGS. 4 and 5 for schematic views of an assembling LED lamp heat dissipating module to a lamp house and using the present invention respectively, a flange 311 is disposed at an internal wall of the lamp house 30 and embedded into an embedding slot 143 of the conducting base 14, such that the heat dissipating module 10 can be embedded into the lamp house 30, and the heat generated by the LED light emitting element 20 is conducted to the conducting base 14, absorbed by the evaporation ends 112, 122 of the two flat heat pipes 11, 12, transmitted to the condensation end 111,121, conducted from the condensation ends 111, 121 to the attached heat dissipating body 13, and dissipated from each heat sink 132 to the outside.

In summation of the description above, the invention can achieve the expected objectives and overcome the shortcomings of the prior art. The invention also complies with the requirements of patent application and is thus duly filed for patent application. While the invention has been described by means of specific embodiments, numerous modifications and variations could be made thereto by those skilled in the art without departing from the scope and spirit of the invention set forth in the claims.

What is claimed is:

1. A light emitting diode (LED) lamp heat dissipating module, embedded with a flange of an internal wall of a lamp house for dissipating heat of an LED light emitting element, and the LED lamp heat dissipating module comprising:
at least two flat heat pipes, each having a condensation section and an evaporation section;
a heat dissipating body, including a cylindrical pillar, a plurality of heat sinks radially formed at an external periphery of the cylindrical pillar, and at least two longitudinal through grooves disposed on the cylindrical pillar for inserting the condensation section therein; and
a conducting base, having corresponding first surface and second surface, and the first surface being attached to the evaporation section, and the second surface being attached to the LED light emitting element, and an embedding slot being disposed at the periphery of the conducting base and embedded with the flange of the internal wall of the lamp house, and the conducting base being perpendicular to an axis of the cylindrical pillar.

2. The LED lamp heat dissipating module of claim 1, wherein the flat heat pipe is L-shaped and has a bent section attached to the first surface.

3. The LED lamp heat dissipating module of claim 2, wherein the bent section of each flat heat pipe is installed outwardly.

4. The LED lamp heat dissipating module of claim 1, wherein the heat dissipating body is an aluminum extruded heat dissipating fin.

5. The LED lamp heat dissipating module of claim 1, wherein the heat sink has a plurality of trenches disposed on a surface of the heat sink.

6. The LED lamp heat dissipating module of claim 1, wherein the conducting base has a penetrating hole for passing a power supply line of the LED light emitting element.

7. The LED lamp heat dissipating module of claim 1, wherein the conducting base has a containing space for containing the LED light emitting element, and the top of the containing space is the second surface.
